(19) United States
(12) Patent Application Publication
(10) Pub. No.: US 2013/0026902 A1
(43) Pub. Date: Jan. 31, 2013

(54) LED PACKAGE FOR INCREASING ILLUMINATION AND SPOTLIGHTING

(71) Applicant: Chao-Chuan CHEN, Taichung City (TW)

(72) Inventor: Chao-Chuan CHEN, Taichung City (TW)

(21) Appl. No.: 13/192,464

(22) Filed: Jul. 28, 2011

(51) Int. Cl. H01K 1/30; H01K 1/26

(52) U.S. Cl. 313/113; 313/110

(57) ABSTRACT

A LED package for increasing illumination and spotlighting includes a base, a LED chip and an enclosure. The enclosure is made of an optically transparent silicone for increasing the illuminative range. In addition, a light-guide curved surface can be placed on the inner side of the enclosure for spotlighting the emitting light in a certain orientation.

### BACKGROUND OF THE INVENTION

1. Field of the Invention

The present invention relates to a LED packaging design, more particularly to a LED packaging design for increasing illumination and spotlighting.

2. Description of Related Art

Recently, the poor emitting efficiency of the light emitting diodes is improved by scientists so that the light emitting diodes are not only used in some appliance for indicating ON/OFF, but also used in the apparatus for lighting today. The current for emitting the conventional LED illuminants is only about 20 mA, but the current for emitting the latest LED illuminants has arrived more than 2 A. The power of one latest LED illuminant is more than 100 times relative to the power of one conventional LED illuminant. Thus, the illumination of one latest LED illuminant is brighter than 100 conventional LED illuminants lighting up simultaneously. The illumination of the latest LED illuminants even reaches 160 lumens. Moreover, the lower electricity cost, the compact size, the fast switching speed, and the duration of the lifetime . . . etc, all of the advantage mentioned above make the latest LED illuminants be applied extensively in the communication field, electronic devices and domestic appliances.

Referring to the drawings to FIG. 4, the conventional LED package comprises a base 51, a LED chip 52 and an enclosure 53. The LED chip 52 is placed on the base 51 and is electrically connecting to the base 51. The LED chip 52 is enclosed by the enclosure 53 on the base 51. A filling material is poured into the enclosure 53 and solidified to form a filling lens 54. However, the enclosure 53 of the conventional LED package is a rubber which impedes the light to pass through freely. Therefore, the partial emitting light from the LED chip 52 cannot pass through the enclosure 53, and the illumination of the LED chip 52 is decreased by the enclosure 53 (as the dashed arrow lines shown in FIG. 4).

The present invention has arisen to mitigate and/or obviate the disadvantages of the conventional.

### SUMMARY OF THE INVENTION

The main objective of the present invention is to provide an improved LED package for increasing illumination and spotlighting.

To achieve the objective, a LED package for increasing illumination and spotlighting comprises a base, a LED chip and an enclosure, the enclosure being made of an optically transparent silicone, the sub layer being made from an optical micro structure which reflects the light;

wherein the LED chip is placed on the base and is electrically connecting to the base, the LED chip enclosed by the enclosure on the base, a filling material poured into the enclosure and solidified to form a filling lens such that the LED chip is packaged in the filling lens, an inner side of the enclosure having a light-guide curved surface deposited thereon, the light-guide curved surface having a sub layer coated thereon for reflecting the emitting light from the LED chip.

Further benefits and advantages of the present invention will become apparent after a careful reading of the detailed description with appropriate reference to the accompanying drawings.

### BRIEF DESCRIPTION OF THE DRAWINGS

FIG. 1 is an assembled view of a LED package for increasing illumination and spotlighting in accordance with the present invention;

FIG. 2 is an assembled view of the LED package for increasing illumination and spotlighting for showing a light-guide curved surface deposited on an inner side of an enclosure;

FIG. 3 is a partial enlarged view of the LED package for increasing illumination and spotlighting for showing a sub layer coated on the light-guide curved surface as shown in FIG. 2; and

FIG. 4 is an assembled view of the prior art.

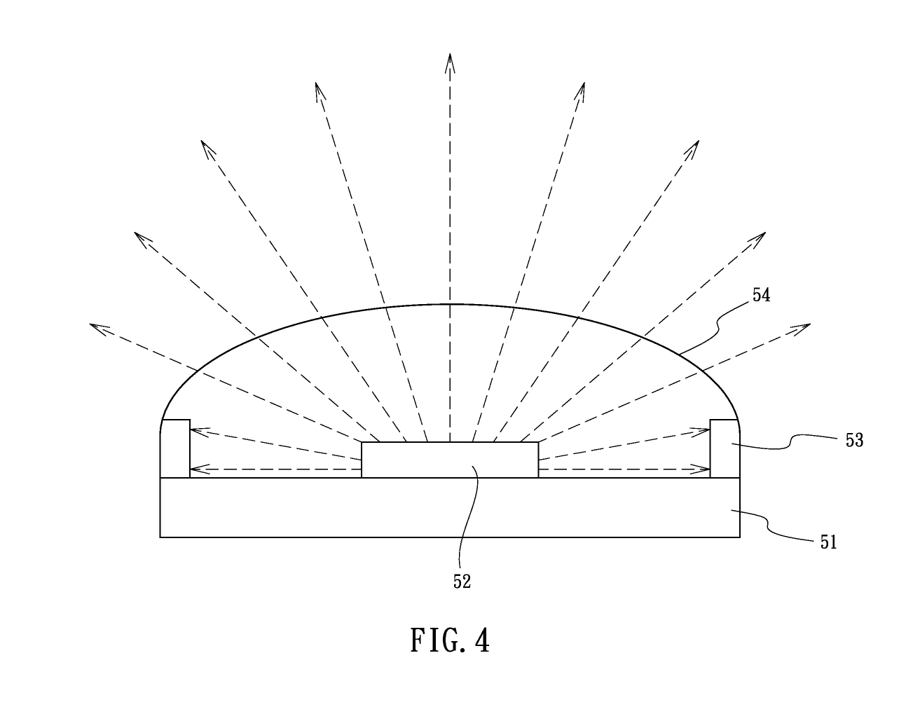

### DETAILED DESCRIPTION OF THE INVENTION

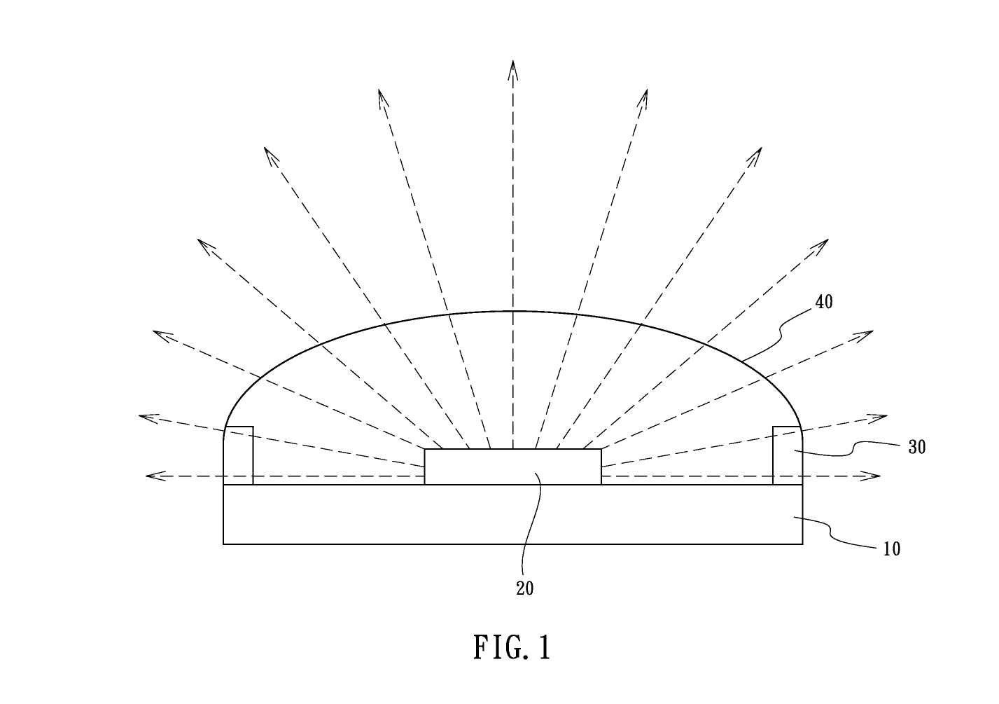

Referring to the drawings to FIG. 1, a LED package for increasing illumination and spotlighting in accordance with the present invention comprises a base 10, a LED chip 20 and an enclosure 30. The LED chip 20 is placed on the base 10 and is electrically connecting to the base 10. The LED chip 20 is enclosed by the enclosure 30 on the base 10. A filling material is poured into the enclosure 30 and solidified to form a filling lens 40 such that the LED chip 20 is packaged in the filling lens 40. The enclosure 30 is made of an optically transparent silicone. Therefore, the emitting light from the LED chip 20 can pass through the enclosure 30 and the emitting light is emitted above the base 10 in all directions (as the dashed arrow lines shown in FIG. 1).

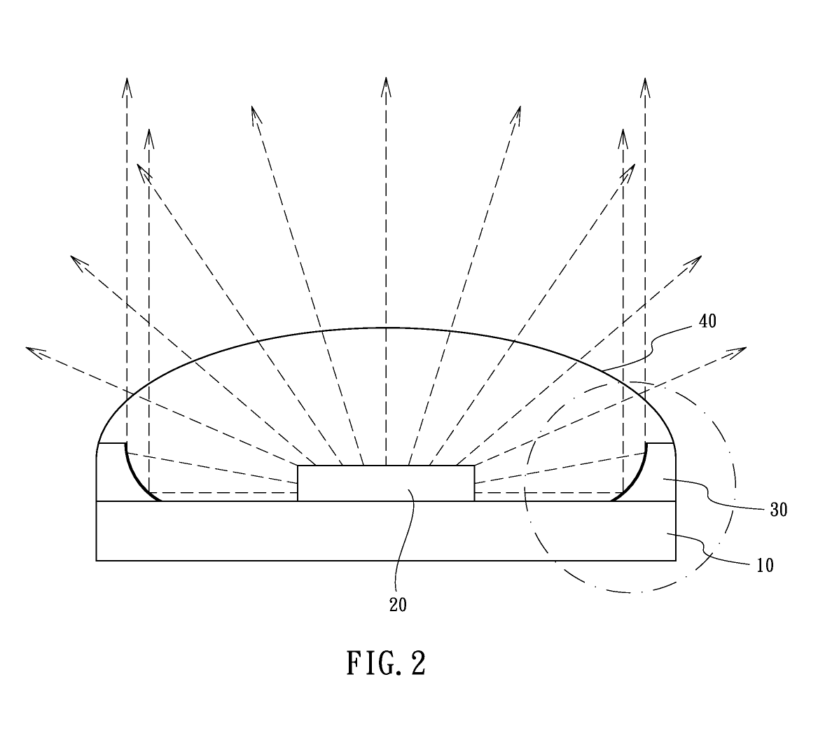

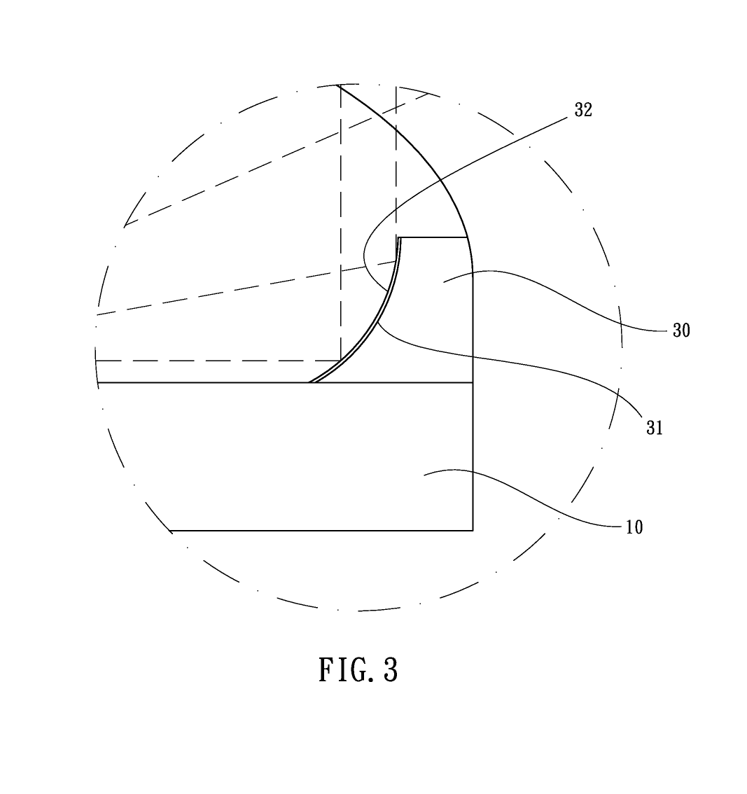

Referring to the drawings to FIGS. 2-3, the LED package for increasing illumination and spotlighting can focus the emitting light on a certain orientation. The LED package for increasing illumination and spotlighting further comprises a base 10, a LED chip 20 and an enclosure 30. The LED chip 20 is placed on the base 10 and is electrically connecting to the base 10. The LED chip 20 is enclosed by the enclosure 30 on the base 10. A filling material is poured into the enclosure 30 and solidified to form a filling lens 40 such that the LED chip 20 is packaged in the filling lens 40. An inner side of the enclosure 30 has a light-guide curved surface 31 deposited thereon. The light-guide curved surface 31 has a sub layer 32 coated thereon for reflecting the emitting light from the LED chip 20. The sub layer 32 is made from an optical micro structure which reflects the light. Therefore, the emitting light from the LED chip 20 is reflected by the light-guide curved surface 31 and the sub layer 32. The reflecting light can travel toward a certain orientation for spotlighting when the curvature of the light-guide curved surface 31 is at a suitable value (as shown in FIG. 2-3, the reflecting light is toward the upside for spotlighting).

Furthermore, the filling material for forming the filling lens 40 can be epoxy resins, spin-on glass (SOG), polyimide, B-staged bisbenzocyclobutene, cermet, or glass to form a uniform filling lens 40 or to form multilayer filling lens 40.

Although the invention has been explained in relation to its preferred embodiment, it is to be understood that many other possible modifications and variations can be made without departing from the spirit and scope of the invention as hereinafter claimed.

What is claimed is:

1. A LED package for increasing illumination and spotlighting comprising:
a base, a LED chip and an enclosure being made of an optically transparent silicone;
wherein the LED chip is placed on the base and is electrically connecting to the base, the LED chip enclosed by the enclosure on the base, a filling material poured into the enclosure and solidified to form a filling lens such that the LED chip is packaged in the filling lens.

2. A LED package for increasing illumination and spotlighting comprising:
a base, a LED chip and an enclosure;
wherein the LED chip is placed on the base and is electrically connecting to the base, the LED chip enclosed by the enclosure on the base, a filling material poured into the enclosure and solidified to form a filling lens such that the LED chip is packaged in the filling lens, an inner side of the enclosure having a light-guide curved surface deposited thereon, the light-guide curved surface having a sub layer coated thereon for reflecting the emitting light from the LED chip.

3. The LED package for increasing illumination and spotlighting as claimed in claim 2, wherein the sub layer is made from an optical micro structure which reflects the light.
